(19) United States
(12) Patent Application Publication
(10) Pub. No.: US 2006/0241222 A1
(43) Pub. Date: Oct. 26, 2006

(54) Method for preparing a silica suspension in an potentially crosslinkable silicone material

(75) Inventors: Marc Chaussade, Villeurbanne (FR); Martial Deruelle, Millery (FR)

Correspondence Address: BUCHANAN, INGERSOLL & ROONEY PC, POST OFFICE BOX 1404, ALEXANDRIA, VA, 22313-1404, US

(73) Assignee: RHODIA CHIMIE, Boulogne Billancourt (FR)

(21) Appl. No.: 10/541,139

(22) PCT Filed: Dec. 19, 2003
(86) PCT No.: PCT/FR03/03817

§ 371 Date: Mar. 9, 2006

(30) Foreign Application Priority Data
Dec. 30, 2002 (FR) 0216868

(51) Int. Cl. B60C 1/00

(52) U.S. Cl. 524/261; 524/492; 524/588

(57) ABSTRACT

The invention concerns a method for preparing a precipitated silica suspension in a silicone oil, said suspension being useable for producing silicones crosslinkable by polyaddition, polycondensation or condensation by dehydrogenation (elastomers). The invention aims at solving the problem of finding a compromise between cost, rheology and mechanical properties of the final elastomers. Therefore, the invention provides a method for preparing a precipitated silica suspension treated with trimethylchlorosilane, in the presence of hexamethyldisiloxane, in a crosslinkable silicone oil. HCl can be used. Grafting of the hydrophobic units on the silica and incorporation of the polyorganosiloxane silicone material are carried out during one single processing sequence, without passing through the powder form for the silica. Sodium silicate promoting MQ resin can be incorporated in the reaction medium. The invention also concerns the preparation of a crosslinkable silicone elastomer composition from said suspension, and the resulting composition.

The field of the invention is that of charged silicones, and in particular silicone elastomers which can be crosslinked by polyaddition or polycondensation and of antifoam silicone compositions.

More precisely, the present invention relates to the preparation of an intermediate product which is useful for producing these elastomers and these antifoam silicone compositions. This intermediate product consists of a suspension of fine filler (as defined below):
in a polyorganosiloxane (POS) not carrying reactive functional groups,
or in a polyorganosiloxane carrying Si-alkenyl—preferably Si-Vi—functional groups capable of reacting by polyaddition with the Si—H crosslinking functional groups of another POS,
or in a polyorganosiloxane carrying Si—OR⁰ (preferably Si—OH) functional groups capable of reacting by hydrolysis/polycondensation.

In the case of silicone elastomers, the fillers considered are reinforcing-fillers, which are to be distinguished from nonreinforcing fillers.

The reinforcing fillers most commonly used are preferably pyrogenic silicas having a BET surface area ≧50 m²/g. They owe their reinforcing effect, on the one hand, to their morphology and, on the other hand, to the hydrogen bonds which form between the silanol groups on the surface of the silicas and the polyorganosiloxane chains. These interactions between the filler and the polymer increase the viscosity and modify the behaviour of the polymer in the vicinity of the solid surface of the fillers. Moreover, the bonds between polymers and fillers improve the mechanical properties but may also cause damaging premature hardening (“structuring”) of the elastomer precursor compositions.

The nonreinforcing fillers have an extremely weak interaction with the silicone polymer. They are for example chalk, quartz powder, diatomaceous earth, mica, kaolin, aluminas and iron oxides. Their effect is often to increase the viscosity of the uncured precursors of the elastomers, and the Shore hardness and the modulus of elasticity thereof.

The silicone elastomers may also contain, inter alia, catalysts, inhibitors, crosslinking agents, pigments, antiblocking agents, plasticizers and adhesion promoters.

These elastomers, crosslinkable by polyaddition or polycondensation, are formed before crosslinking by casting, extrusion, calendering, coating, with a brush or with a gun, or by compression moulding, by injection or by transfer.

The silicone compositions, cold-crosslinkable into elastomers by polyaddition at room temperature or at higher temperatures (generally <200° C.), are conventionally packaged in the form of two-component systems; that is to say comprising two parts which are packaged separately and have to be mixed at the time of use.

In these two-component systems, one of the components comprises the polyaddition reaction catalyst. This catalyst is preferably of the platinum type. It may be for example a platinum complex such as that prepared from chloroplatinic acid and 1,3-divinyl-1,1,3,3-tetramethyldisiloxane, according to patent U.S. Pat. No. 3,814,730 (Karstedt catalyst). Other platinum complexes are described in patents U.S. Pat. Nos. 3,159,601, 3,159,662 and 3,220,972.

This component containing the catalyst generally additionally comprises a type A-POS with crosslinking functional groups Fa: Si-alkenyl, preferably Si-vinyl.

The other component, without catalyst, comprises at least one type B POS with crosslinking functional groups Fb: Si—H.

Generally, the type A POSs and the type B POSs comprise at least two groups Si-Vi and Si—H, respectively, per molecule, preferably at the α,ω position for the type A POSs; at least one of the two having to comprise at least three crosslinking functional groups per molecule.

These two-component systems may also contain a platinum inhibitor which allows the components to only crosslink once mixed together, optionally having been heated. As examples of inhibitors, there may be mentioned: polyorganosiloxanes, advantageously cyclic polyorganosiloxanes, substituted with at least one alkenyl, tetramethylvinyltetrasiloxane being particularly preferred, pyridine, phosphines and organic phosphites (Irgafos® P-EPQ, for example), unsaturated amides, alkylated maleates, and acetylenic alcohols (cf. FR-B-1 528 464 and FR-A-2 372 874). Such compositions may also be provided in the form of one-component systems which crosslink only after having been heated.

The silicone compositions, which can be crosslinked or hardened into elastomers by polycondensation at room temperature or at higher temperatures (generally <100° C.), are conventionally packaged in the form of one-component systems (that is to say comprising a single packaging) or two-component systems (that is to say comprising two parts packaged separately and which have to be mixed at the time of use).

In the two-component systems, one of the components comprises in particular a type C POS having reactive ends Fc, in particular hydroxydimethylsiloxy, the other component containing the polycondensation reaction catalyst. This catalyst may be a metal compound, for example an organic compound of tin. This compound containing the catalyst may also comprise a crosslinking agent D carrying functional groups Fd capable of reacting with the reactive functional groups Fc of the C POS.

Such compositions may also be present in the form of one-component systems which crosslink at room temperature, in the presence of moisture.

In the case of antifoam compositions based on nonreactive silicones, the fillers used are particular fillers such as those mentioned above for the elastomer compositions. These fillers act through their non-deformable character, their geometry and their dimensions and through the interactions which they exchange with the surrounding medium.

The preparation of concentrated suspensions (slurries) of particulate reinforcing fillers in reactive or nonreactive silicone oils intended to produce crosslinkable elastomers or antifoam silicone compositions, is a stage of the methods of producing elastomer compositions which is very widespread in the field of silicone elastomers.

The particulate reinforcing fillers most widely known are based on pyrogenic silica, but substances such as precipitated silica, titanium oxide, for example, may also be used in some cases.

These fillers have a BET specific surface area of at least 1 m²/g up to generally 400 m²/g. They are ultrafine powders which may be dispersed in silicone oils. This dispersion poses problems of mixing the pulverulent filler with oil and care should be particularly taken to obtain a uniform distribution of the filler in the suspension.

Another difficulty to be overcome is linked to the rheology of the suspensions prepared. Indeed, it is clear that the introduction into silicone oil of a pulverulent particulate filler of very small particle size necessarily introduces a notable increase in the viscosity. However, this characteristic, although it is associated with the obtaining of good mechanical properties for the silicone elastomers comprising the suspension as raw material, is damaging to the handling and to the forming of the suspension and of the silicone compositions containing it. It is indeed more convenient, for moulding, extrusion, coating or forming, to handle fluid compositions which readily lend themselves, inter alia, to pumping, flowing or mixing with functional additives.

As regards the antifoams, fluid compositions are generally sought; the use of a manufacturing intermediate consisting of a concentrated suspension in accordance with the invention, described below, is a means for achieving this objective.

These problems linked to the handling of the reinforcing fillers and to the very high viscosity of the slurries containing them cause a third major disadvantage of an economic nature linked to the complexity of the materials to be used.

The problem considered here can therefore be summarized as being the search for a new method for preparing suspensions of fine particulate fillers in silicone oils:
which leads to homogeneous suspensions having a fine distribution of particles in the silicone matrix,
which offers matching of the rheology of the suspension to the handling constraints (“processability”),
which makes it possible to obtain in fine crosslinked elastomers having satisfactory mechanical properties,
and which is economical.

A number of methods for preparing suspensions of fine particulate fillers in silicone oils coupled with a compatibilization treatment of the fine particulate filler (silica) are known. This treatment is intended to make the reinforcing—preferably silicic—filler compatible with the silicone phase. Indeed, this type of rather hydrophilic filler gains in becoming hydrophobic in order to be able to better exert its function of mechanical reinforcement of the silicone material, once crosslinked.

There are two main types of compatibilizing agents:
those based on HexaMethylDisilaZane (HMDZ),
and those based on halosilanes (chlorosilanes).

This compatibilization treatment can take place before and/or during and/or after the incorporation of the filler (e.g. silica) into the polyorganosiloxane oils.

Numerous patent documents relate to the preparation of HMDZ-treated silica suspensions in a polyorganosiloxane silicone material.

It is thus the case for the following references:

French patent application FR-A-2 320 324-describes a method for the homogeneous distribution, in polyorganosiloxane oils, of a filler based on highly, dispersed pyrogenic silica having a BET specific surface area of at least 50 m²/g. This method is characterized in that the filler is treated during the incorporation, in the presence of water, with a compatibilizing agent (hexamethyldisilazane). This compatibilization treatment of silica with silicone oil may be termed “early” since the HMDZ is present from the bringing of the reinforcing fumed silica into contact with this silicone oil.

European patent application EP-A-0 462 032 describes a method for preparing a slurry which can be used in particular in compositions which can be crosslinked by polyaddition reaction. In this method, the compatibilization treatment using hexamethyldisilazane occurs after the incorporation of silica into the silicone oil. This mode of treatment is termed here “late”.

American patent U.S. Pat. No. 4,785,047 discloses a mixed compatibilization treatment at the frontier between the early and the late treatments mentioned above. This patent relates more specifically to a method for preparing transparent silicone elastomers.

Patent applications PCT WO-A-98/58997 and WO-A-00/37549 relate to methods for preparing slurries containing reactive silicone oils by polyaddition and polycondensation, respectively, in which a first HMDZ fraction (less than 8% in total) is introduced before bringing into contact with the silicone oil/powdered fumed silica and the remainder of the HMDZ afterwards.

Patent application PCT WO-A-02/44259 discloses the preparation of a precipitated silica suspension in a silicone oil, it being possible for this suspension to be used for producing silicones crosslinkable by polyaddition or by polycondensation (RTV elastomers). The precipitated silica is treated with hexamethyldisilazane (HMDZ) introduced in two fractions (15 and 85%) into a crosslinkable silicone oil. The first fraction is first of all brought into contact with precipitated silica and water.

As regards preparations of silicone compositions comprising a silicic filler made hydrophobic with chlorosilanes, the following patent documents may be mentioned:

Patent U.S. Pat. No. 3,122,520 discloses the hydrophobization of silica, which consists in bringing an aqueous silica slurry into contact with HCl and in heating this mixture to between 50 and 250° C. (pH close to 0). Isopropyl alcohol and hexamethyldisiloxane are then added. isopropyl alcohol or any other organic solvent immiscible with water allows the transfer of the “hydrophobized” silica into an organic phase. The aqueous phase is separated from the organic phase and the removal of this aqueous phase is completed by a devolatilization step.

The document WO-A-01/14480 teaches the presence of a coupling agent (a) (e.g. MeViSiCl₂) and of an organometallic hydrophobizing compound (b) (e.g. Me₂SiCl₂). Isopropyl alcohol, HexaMethylDiSiloxane (HMDS or M₂) or toluene also form part of the reagents in addition to the aqueous silica slurry. The temperature is also increased (65° C.).

The content of the document WO-A-01/12730 is comparable to that of the document WO-A-01/14480. The hydrophobization of silica in the form of an aqueous slurry is carried out at acidic pH (H₂SO₄ or HCl), in the presence of isopropanol, of HMDS with heating to 60-70° C. The abovementioned hydrophobized silica particles are then transferred into an organic phase based on hexane for example. The aim is to have 2 to 15 OH/nm², a methanol wettability of 15 to 45% and, after neutralization, a reduced carbon content (close to 0) and a pH between 3 and 10 and a whiteness M₁ of less than 0.4%.

The document EP-A-1 048 696 (=U.S. Pat. No. 6,184,408) relates to a process for preparing precipitated silica, in which this precipitated silica is mixed with isopropyl alcohol, with water, with HMDS, and then with concentrated HCl and finally again with isopropyl alcohol. After mixing for three hours at room temperature, toluene is used in which the transfer of the hydrophobized precipitated silica occurs.

HMDS may be replaced by Me₂SiCl₂.

The document U.S. Pat. No. 5,919,298 discloses the treatment of fumed silica with HMDS, HCl, water and isopropanol. The hydrophobization is carried out at room temperature. This patent also discloses the replacement of HMDS by a hexenyldimethylchlorosilane and dimethyldichlorosilane combination, with subsequent use of hexane to carry out the transfer of Hydrophobized silica into an organic phase.

In the document WO-A-99/36356, the silica used is in the form of an aqueous slurry and the reaction medium comprises Me₂SiCl₂ in addition to isopropanol and HCl. The transfer takes place in heptane. The hydrophobization is carried out at room temperature.

In all these documents-illustrating the chlorosilane route for the compatibilization treatment, the “hydrophobized” reinforcing silica is isolated in powdered form, so as to be stored in this state and then incorporated-into a silicone material comprising crosslinkable polyorganosiloxane oils. They do not therefore involve continuous processes for preparing silicone compositions charged with hydrophobic silica, comprising both the hydrophobization treatment and the mixing of this silica with polyorganosiloxane silicone materials.

These known methods are not therefore the most economical because of their complexity (numerous handlings), and large quantities of energy which they require for making into hydrophobic silica powders and for mixing these powders with polysiloxane oils, which may be relatively viscous.

American patent U.S. Pat. No. 5,942,590 describes the preparation of a silica gel in which a colloidal silica is incorporated, this silica gel being made hydrophobic by treatment with dimethyldichlorosilane at pH 5.5. According to this preparation, a silica hydrogel is prepared from sodium silicate and water acidified with HCl. Colloidal silica is added to this hydrogel, and the pH of the solution thus obtained is adjusted to 2.5. The passage of the ph from 2.5 to 5.5 and the addition of a sodium-silicate solution causes the conversion of the silica suspension into a silica gel. After removing part of the water by heating under reflux, with stirring, for two hours, the silica gel is supplemented with isopropanol and dimethyldichlorosilane. This addition is followed by a heating step in which the silica is functionalized with dimethyldichlorosilane. After removing water, HCl and isopropanol by decantation, a hydrophobic silica is recovered in toluene. The latter is then removed by thermal devolatilization in order to obtain a dry hydrophobic gel. Dimethyldichlorosilane may be replaced by hexamethyldisiloxane (M₂).

These hydrophobic dry silica gels may be used as a reinforcing filler in silicone elastomer compositions.

The necessary passage via a dry hydrophobic silica gel is a notable disadvantage of the technical content of the document. Indeed, this suggests an expensive heat treatment, which makes the process more complex. In addition, it should be emphasized that the planned adjustments of pH in the method according to U.S. Pat. No. 5,942,950 are not easy to use in an industrial process. Furthermore, they are capable of generating awkward salts in particular because they induce instability, they carry residual hydrophilicity and they can interfere with the transparency of the material.

In such a technical context, one of the main objectives of the present invention is to provide an economical method for preparing a suspension of a particulate filler treated with a compatibilizing agent based on aminosilanes or halosilanes, in a silicone oil, it being possible for this suspension to be useful as raw material for producing:
two-component, or even one-component, silicone compositions which can be crosslinked in particular by polyaddition, polycondensation or dehydrogenocondensation to silicone elastomers,
or antifoam silicone compositions.

This method has to satisfy the following specifications:
coupling in one and the same manufacturing sequence the compatibilization treatment of silica in particular using aminosilanes or halosilanes and mixing the silica with a polysiloxane silicone material which can be used directly as raw material for the preparation of crosslinkable silicone compositions,
uniformization and homogenization of the distribution of the filler in the silicone oil,
optimization of the dispersion,
viscosity matched to handling and conversion of the suspension,
mechanical properties of the elastomers resulting from an acceptable level, or quality antifoam properties,
reduced cost.

Another main objective of the invention is to provide a method for preparing a reinforcing filler/silicone oil suspension for elastomers, which is suitable for silicone materials (oils) having a long chain length (for example having at least 100 units D—cf. nomenclature below—) and which are therefore viscous and difficult to mix even in high-power mixers.

Another main objective of the invention is to provide a method for preparing a reinforcing filler/silicone oil suspension for elastomers, which is simple to use and applicable on an industrial scale.

Another main objective of the invention is to provide an efficient and direct method for producing a reinforcing filler suspension in a silicone oil for elastomers, this method being of the type referred to in the abovementioned objectives.

Another main objective of the invention is to provide a method for producing a silicone composition which can be crosslinked by polyaddition, polycondensation or even dehydrogenocondensation, for forming an elastomer and comprising, as constituent element, the suspension as obtained by the method referred to above.

Another main objective of the invention is to provide a method for producing an antifoam silicone composition and comprising, as constituent element, the suspension as obtained by the method referred to above.

These objectives, among others, are achieved by the present invention which relates, according to a first embodiment, to a method for preparing a suspension of a silicic particulate filler, in a silicone material (SM) comprising:

SM₁polyaddition:

at least one type A polyorganosiloxane POS carrying alkenyl crosslinking functional groups Fa capable of reacting with the crosslinking functional groups Fb (SiH) of at least one B type POS, this A POS being taken alone or as a mixture with at least one nonreactive (E) POS;
and at least one B type POS carrying crosslinking functional groups Fb (SiH) capable of reacting with the alkenyl crosslinking functional groups Fa of the A POS(s);
   and/or SM₂polycondensation:
at least one C type POS carrying hydroxyl crosslinking functional groups Fc and/or OR functional groups (R=C₁-C₃₀ alkyl, C₂-C₃₀ alkenyl, aryl, which are optionally substituted (preferably halogenated)) precursor of the functional groups Fc′, these crosslinking functional groups Fc being capable of reacting with crosslinking functional groups Fc of this C POS or of other C POSs, and with crosslinking functional groups of at least one crosslinking agent D, this C POS being taken alone or as a mixture with at least one nonreactive (E) POS;
   and/or SM₃polydehydrogenocondensation:
at least one C′ type POS carrying hydroxyl crosslinking functional groups Fc′ and/or OR′ functional groups (R′═C₁-C₃₀ alkyl, C₂-C₃₀ alkenyl, aryl, which are optionally substituted (preferably halogenated)) precursor of the functional groups Fc′, these crosslinking functional groups Fc′ being capable of reacting with other crosslinking functional groups Fb′ (SiH) of at least one B′ type POS, this C′ POS being taken alone or as a mixture with at least one nonreactive (E) POS;
and at least one B′ type POS carrying crosslinking functional groups Fb′ (SiH) capable of reacting with the crosslinking functional groups Fb′ OH or OR′ of the C′ POS(s);
   and/or SM₄:

or at least one nonreactive (E) POS;

this suspension being capable of being used in particular for producing compositions which can be crosslinked by polyaddition and/or by polycondensation and/or by dehydrogenocondensation or antifoam silicone compositions;

this method being of the type in which an aqueous suspension of silicic particulate filler is made hydrophobic by treating with at least one halogenated reagent, this treatment comprising a transfer of the silica made hydrophobic into a nonaqueous phase and at least one step for at least partial removal of water;

the compatibilizing agent (CA) being:
CA I (Route I): either selected from silazanes, taken alone or as a mixture with each other, preferably from disilazanes, hexamethyldisilazane (HMDZ) combined or otherwise with divinyltetramethyldisilazane being particularly preferred;
CA II (Route II): or selected from R^{c}-substituted halogenosilanes with R^{c}=hydrogeno, C₁-C₃₀ alkyl, C₂-C₃₀ alkenyl, aryl, and R^{c} being optionally substituted (preferably halogenated), preferably from R^{c}-substituted chlorosilanes and the Mixtures thereof;
   the said method being characterized:
   1. in that:

according to route I:
Ia)—the particulate filler is selected from the group of precipitated silicas,
Ib)—the compatibilizing agent (CA.I) is added in one or more fractions which are quantitatively and/or qualitatively identical to or different from each other, to the preparation medium,
Ic)—the mixing of all or part of the SM, of the filler, of water, and of the CA or CAs is optionally partly carried out in the hot state and in such a manner that the quantity of water is such that the weight ratio r=(water/water+silica)×100 is defined as follows: 40≦r≦99, preferably 60≦r≦90,
Id)—optionally at least some of the water released and of the by-products of the reaction of CA.I with SM and with the filler are drawn off,
Ie)—the volatile species are optionally removed, preferably in the hot state under a gaseous stream or under vacuum,
If)—and cooled if necessary,
   according to route II:
IIa)—an aqueous silica suspension is prepared or used which comprises:
   silica,
   water which is optionally acidified,
   at least one hydrogen bond stabilizer, preferably in such a manner that the pH of this suspension is ≦2, preferably ≦1,
IIb)—optionally, part of the silicone material SM is incorporated into the aqueous silica suspension obtained at the end of step IIa),
IIc)—hydrophobic units formed by ≡Si—(R^{c})_{1 to 3} with R^{c}=hydrogen, C₁-C₃₀ alkyl, C₂-C₃₀ alkenyl, aryl, these groups R^{c} being optionally substituted (preferably halogenated), are grafted onto the silica by exposing this silica to halosilane type CA II acting as precursors of these units and by allowing the reaction to proceed, preferably while stirring the whole, optionally in the hot state,
IId)—the procedure is carried out such that the transfer of the silica grafted by hydrophobic units, from the aqueous phase to the nonaqueous phase, is carried out,
IIe)—optionally, at least part of the aqueous phase and of the reaction by-products is drawn off,
IIf)—the medium is cooled if necessary,
IIg)—optionally, the residual acidity of the nonaqueous phase is washed off,
IIh)—the totality or the remainder of the silicone material SM is mixed with the filler which is now hydrophobic,
IIi)—the residual water is evaporated off,
IIj)—and an oil is recovered which consists of a hydrophobic particulate filler suspension in a crosslinkable silicone material, preferably without ever passing via a dried hydrophobic silica,
   the routes I and II leading to an oil (or slurry) consisting of a suspension of hydrophobic particulate filler in a crosslinkable silicone material,
   and in that at least one other compatibilizing agent (CA III) is used which is chosen from the group comprising:
(i) POSs carrying in and/or at the ends of their chains compatibilizing functional groups OR^{IIIi} in which R^{IIIi} independently corresponds to hydrogen or to a radical corresponding to the same definition as given above for R^{c};
(ii) siloxane resins;
(iii) silanes;
(iv) and mixtures thereof;
   excluding:
di- or monofunctional low-molecular-weight (advantageously less than 1 000 g/mol) siloxanes with hydroxyl ends;
amines, such as, for example alkylamines, (such as diethylamine) and/or silylamines;
and surfactants and more particularly cationic surfactants.

According to a second embodiment of the invention, the compatibilizing agent (CA III) is chosen from the group comprising:
(i) POSs carrying in and/or at the ends of their chains compatibilizing functional groups OR^{IIIi} in which R^{IIIi} independently corresponds to hydrogen or to a radical corresponding to the same definition as given above for R^{c};
(ii) siloxane resins;
(iii) silanes;
(iv) and mixtures thereof;
   provided that C1 according to which if CA=CA I and if CA III comprises at least one α,ω-dihydroxylated POS (i),
   then the latter is combined with at least one element of the subgroups (ii) to (iii);
   and without excluding:
di- or monofunctional low-molecular-weight (advantageously less than 1 000 g/mol) siloxanes with hydroxyl ends;
amines, such as for example alkylamines, (such as diethylamine) and/or silylamines;
and surfactants and more particularly cationic surfactants.

According to a third embodiment of the invention, the compatibilizing agent (CA III) is chosen from the group comprising:
(i) POSs carrying in and/or at the ends of their chains compatibilizing functional groups OR^{IIIi} in which R^{IIIi} independently corresponds to hydrogen or to a radical corresponding to the same definition as given above for R^{c};
(ii) siloxane resins;
(iii) silanes;
(iv) and mixtures thereof;
   provided that C2 according to which if CA=CA I, then CA I is different from any-compatibilizing agent selected from silazanes, taken on their own or as a mixture with each other, in particular disilazanes such as hexamethyldisilazane (HMDZ) combined or otherwise with divinyltetramethyldisilazane:
   and without excluding:
di- or monofunctional low-molecular-weight (advantageously less than 1 000 g/mol) siloxanes with hydroxyl ends;
amines, such as, for example alkylamines, (such as diethylamine) and/or silylamines;
and surfactants and more particularly cationic surfactants.

According to a fourth embodiment of the invention, the compatibilizing agent (CA III) is chosen from the group comprising:
(i) POSs carrying in and/or at the ends of their chains compatibilizing functional groups OR^{IIIi} in which R^{IIIi} independently corresponds to hydrogen or to a radical corresponding to the same definition as given above for R^{c};
(ii) siloxane resins;
(iii) silanes;
(iv) and mixtures thereof.

This compatibilizing agent (CA III) is combined with at least one condensation catalyst preferably selected from:
strong bases, and still more preferably from the subgroup comprising: KOH, LiOH, NaOH and mixtures thereof;
metal salts, and still more preferably from the subgroup comprising: tin salts, titanium salts and mixtures thereof;
salts of triflic acid;
and mixtures thereof.

This fourth embodiment does not envisage the exclusion of:
di- or monofunctional low-molecular-weight (advantageously less than 1 000 g/mol) siloxanes with hydroxyl ends;
amines, such as, for example alkylamines, (such as diethylamine) and/or silylamines;
and surfactants and more particularly cationic surfactants.

It is to the credit of the inventors, after numerous research studies and experiments, to have discovered novel compatibilizing agents CA III which substantially improve the cohesion- and the homogeneity of the hydrophobic silica suspension/silicone oil and therefore in fine the mechanical reinforcing functions provided by the filler in the silicone.

It was all the less obvious to envisage the use of CA III as such compatibilizing agents lead to perfectly well treated silicas which do not require post-treatment.

The advantages of this novel method for producing silicic suspensions are in particular:
significant reduction in cost;
ease of use;
production of suspensions having appropriate rheological qualities and viscoelastic behaviour (no or low yield point with a viscosity adjusted according to the silica content and the viscosity of the oils used); in particular they have a fluidity which is stable over time and suitable for the handling and processing operations, such as pumping, conveying, mixing, forming, moulding, extrusion, and the like, including for long silicone oils which are therefore already intrinsically viscous;
ease of use degassing for the elastomer compositions prepared from these suspensions;
and moreover improved transparency of the elastomer compositions prepared from these suspensions.

One of the major advantages of the invention is that this economic benefit is not achieved at the expense of the other advantages of the method and of the final mechanical properties of the crosslinked elastomer or of the antifoam properties, depending on the case.

For the purposes of the invention, the possibility attached in route II at step IIe) of drawing off the aqueous phase is interpreted as follows:
for an elastomeric silicone composition, step IIe) is obligatory and it is even completed by a devolatilization (distillation) in order to completely eliminate the volatiles including water;
for an antifoam silicone composition, it is possible optionally to dispense with the removal of the volatile species including water, for subsequent emulsification.

Still in route II, the expression “dried hydrophobic silica” is understood to mean, for the purposes of the present invention and in the whole of the present disclosure, a hydrophobic silica containing less than 10% of extractables not attached to the hydrophobic silica. The term “extractables” denoting:
either volatile products which can be removed from the hydrophobic silica by treating for one hour at 150° C., at normal atmospheric pressure;
or products extractable from hydrophobic silica through contact with a solvent for silicones (e.g. hexane, cyclohexane, heptane, CCl₄, octane, dichloromethane, toluene, methyl ethyl ketone, methyl isobutyl ketone, white spirit, xylene), at the rate of 5 and 30% by weight of hydrophobic silica relative to the solvent, for at least 8 days, with stirring, at 25° C. and at normal atmospheric pressure.

Another point to be noted as regards route II is that it may be advantageous to envisage a pH for example of less than or equal to 2, preferably 1, at least during step IIa).

According to a preferred modality of the invention, the compatibilizing agent CA III is incorporated after CA I or CA II, preferably after drawing off all or part of the aqueous phase, provided that the said drawing off takes place.

As regards CA III (i), the α,ω-dihydroxylated POSs more particularly selected are α,ω-bis(dialkylhydroxysiloxy) polydialkylsiloxanes with short chains, for example having a molecular weight of less than or equal to 1 000 g/mol.

The alkyl substituents of these POSs are preferably C₁-C₆ alkyls and still more preferably methyls.

As regards CA III (ii), it is first of all specified that the expression “siloxane resin” is understood to mean, for the purposes of the invention, a resin comprising siloxy units Q and/or T and optionally siloxy units M and/or D and/or Q^{Orq′} and/or T^{Ort′} and/or M^{Orm′} and/or D^{Ord′}.

The following rules of nomenclature are adopted in the present disclosure for the siloxy units:
M:(R^{m})₃SiO_{1/2}
with R^{m}=hydrogen, C₁-C₃₀ alkyl, C₂-C₃₀ alkenyl, aryl, these groups R^{m} being optionally substituted (preferably halogenated)
M^{ORm′}:(R^{m})ₐ(ORm′)_{b}SiO_{1/2}
with R^{m} as defined above and a+b=3 and Rm′=H or a radical having the same definition as R^{m}
D:(R^{d})₂SiO_{2/2}
with R^{d} having the same definition as that given above for R^{m}
D^{Ord′}:(R^{d})(Ord′)SiO_{2/2}
with R^{d} as defined above and Rd′=H or a radical having the same definition as R^{m}
T:(R^{t})SiC_{3/2}
with R^{t} having the same definition as given above for R^{m}
T^{Ort′}:(Ort′)SiO_{3/2}
with Rt′=H or a radical having the same definition as R^{m} 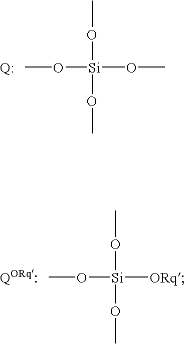
with Rq′=H or a radical having the same definition as R^{m}.

In addition, the siloxane resins CA III (iii) more especially selected are the resins MQ, MM^{ORM′}Q, MQQ^{ORQ′} or MM^{ORM′}QQ^{ORQ′}.

Advantageously, CA III is added in an amount of 0.5 to 40% by weight, preferably 0.5 to 40% by weight relative to the quantity of silicic particulate filler used in the suspension.

It is advantageous to note that the quantities of CA III used are relatively small for a very significant effect of improving the properties of the silica-in-silicone oil “slurry” obtained.

That is the case in particular for CA III (i)=short α,ω-dihydroxylated POS (molecular weight ≦1 000 g/mol) which, for substantially identical silica levels, makes it possible for example to divide the viscosity of the slurries by at least 5.

The invention also relates to a treatment intended to make the silica hydrophobic, this treatment being capable of being carried out in the method for preparing a suspension of a filler (for example a silicic filler) in a silicone.

This method is characterized in that, according to route II:
IIa′) the following are brought into contact:
   an aqueous silica suspension comprising 100 parts by dry weight of silica, optionally acidified with 20 to 60 (preferably 30 to 50) parts by weight of at least one acid, knowing that the pH of the nonaqueous phase is preferably ≦ to 2, and still more preferably ≦ to 1,
   0 to 500 (preferably 0 to 300) parts by weight of a precursor of siloxane silicone resin, preferably sodium silicate,
   5 to 500 (preferably from 10 to 200) parts by weight of a stabilizer/nonaqueous hydrogen bond initiator,
   5 to 500 (preferably from 10 to 200) parts by dry weight of at least one halosilane, precursor of hydrophobic units formed by units —Si—(R^{c})_{1 to 3} with R^{c}=hydrogeno, C₁-C₃₀ alkyl, C₂-C₃₀ alkenyl, aryl, these groups R^{c} being optionally substituted (preferably halogenated),
   40 to 2 000 (preferably from 50 to 800) parts by weight of silicone material SM,
IIb′) the reaction medium thus obtained is heated,
IIc′) the medium is optionally cooled,
IId′) the aqueous phase and reaction by-products are drawn off,
IIe′) the nonaqueous phase comprising the now hydrophobic silica is recovered,
IIf′) optionally the residual acidity of the nonaqueous phase is washed off,
IIg′) optionally the liquid is removed from the nonaqueous phase so as to recover the hydrophobic silica in pulverulent form.

This succession of operations makes it possible to optimize the grafting of hydrophobic units ≡Si—R^{c} onto silica.

Advantageously, in route II, it is possible to use, during step IIa), at least one precursor of siloxane resins (in particular MQ) as defined above. This precursor is preferably a silicate, and still more preferably a sodium silicate.

The precursor of such siloxane resins (preferably a sodium silicate) converts to a polysilicic acid in the presence of acidified water at a pH of preferably ≦2. This acid forms a network of units Q which form aggregates on the silica initially used. The functionalization (“hydrophobization”) of the network using CA II then occurs.

A silicone phase is thus obtained which contains siloxane resin with a core Q which is large in size. The aqueous phase is free of any trace of silica.

The precursor of siloxane resins is used in an amount of 20 to 60, preferably 30 to 50% by weight relative to the particulate filler used.

In practice, the precursor of siloxane resins may be in the form of an aqueous solution.

The conditions for forming siloxane resins are advantageously the following: those conforming to the technical content of patents U.S. Pat. No. 2,676,182 and U.S. Pat. No. 2,814,601.

According to an advantageous variant of the process according to the invention, functional units other than the hydrophobic units are grafted on the silica by bringing the latter into contact with halosilanes which are precursors of these functional grafts.

The functions which may be given to the silica by these units are for example the following: bactericidal, bacteriostatic, chromophoric, fluorescence, anti-fouling, refractive index modifier, coupling with the silicone network (e.g. haloalkoxy-alkenylsilane, and the like) and combinations thereof.

To complete the method according to the invention, the most appropriate conditions proved to be those consisting in choosing:
one or more precipitated silicas, preferably existing mainly in slurry form and whose BET specific surface area is between 50 and 400 m²/g,
and mixing conditions such that the dynamic viscosity at 25° C. of the suspension is less than or equal to 300 Pa·s, preferably less than or equal to 150 Pa·s.

Further details on the preferred precipitated silicas in accordance with the invention are given below.

Conventionally, a precipitated silica results from a succession of operations which may be for example:
precipitation of silica in aqueous phase by acidification, by addition of acid to a stock solution of silicate or by total or partial simultaneous addition of acid and of silicate to a stock solution of water or of silicate solution,

filtration which makes it possible to recover a phase enriched with silica,
optionally disintegration of the precipitated silica filtrate in order to prepare an aqueous suspension which is easy to handle,
optionally drying of the precipitated silica,
optionally grinding and/or compacting of the precipitated silica powder,
and optionally packaging in bags the powdered precipitated silica thus obtained.

The precipitated silica preparation used in the context of the invention is described in the documents EP-A-0 520 862, WO-A-95/09127 and WO-A-95/09128.

Thus, the precipitated silica used in the method according to the invention may be provided in powder form or in the form of an aqueous slurry collected at the filtration or disintegration stage.

For the purposes of the invention, the term “powder” used to describe the precipitated silica denotes precipitated silica in the solid state, generally provided in pulverulent form or in the form of substantially spherical granules or beads.

According to a preferred characteristic of the invention, one or more precipitated silicas are chosen whose BET specific surface area is between 50 and 400 m²/g and mixing conditions such that the dynamic viscosity at 25° C. of the suspension (slurry) is less than or equal to 300 Pa·s, preferably less than or equal to 150 Pa·s. The BET specific surface area is determined according to the BRUNAUER, EMMET, TELLER method described in “The Journal of the American Chemical Society, vol. 80, page 309 (193.8)”corresponding to the NFT 45007 standard of November 1987.

Advantageously, the (precipitated) silica filler preferably represents from 10 to 50% by weight of the suspension. In practice, this filler is of the order of 30±10% by weight.

According to an advantageous characteristic of the invention, the hydrogen bond stabilizer/initiator is chosen from organic solvents, preferably from the group comprising alcohols (in particular isopropyl alcohol, ethanol and butanol), ketones (in particular Methyl IsoButyl Ketone: MIBK), amides (in particular DiMethylACetamide: DMAC), alkanes (in particular tetrahydrofuran: THF) and mixtures thereof.

It may be noted that the acidification of the aqueous suspension (aqueous phase) which may occur in the method according to the invention is otherwise carried out using an acid, preferably an inorganic acid, and still more preferably an acid is chosen from the group comprising: HCl, H₂SO₄, H₃PO₄ and mixtures thereof.

A means other than the external supply of acid in order to maintain the pH of the aqueous suspension (aqueous phase) below the required limit consists in the in situ formation of acid—preferably HCl—by reacting the halosilane precursor of hydrophobic units, with water.

Preferably, the silicone material SM comprises at least one oligoorganosiloxane, preferably a diorganosiloxane, and still more preferably hexamethyldisiloxane (M₂).

The oligoorganosiloxane(s) of the SM may be combined with one or more polyorganosiloxanes (POS) of any type, in particular A, B, C, D, E as referred to above and defined in greater detail below.

For the purposes of the invention, the term “oligoorganosiloxane” denotes a siloxane oligomer comprising from 2 to 10 M, D or T type siloxy units as defined above, while a polyorganosiloxane denotes a polymer comprising from 11 to 10 000 thereof, preferably from 100 to 5 000.

The silicone material SM of an oligoorganosiloxane nature preferably corresponds to the first fraction optionally used in step IIb) of the method according to the invention for preparing a silica suspension in a silicone oil.

According to a preferred but nonlimiting characteristic, the halosilane precursor of hydrophobic units is an alkylhalosilane, preferably an alkylchlorosilane, and still more preferably a methylchlorosilane.

This alkylhalosilane is very advantageously a monosilane type blocker, for example (CH₃)SiCl. This blocker limits the growth of the silica, or even of the siloxane resin derived from the silicate, preferably sodium silicate, used in step IIa) or IIa′).

In accordance with the invention, it is not out of the question to provide additionally or as a replacement for the preferred blocker(s) referred to above one or more halosilanes which are different and chosen from the group comprising:
dialkyldihalomonosilanes, for example (CH₃)₂SiCl₂,
dialkylhydrogenohalomonosilanes, for example (CH₃)₂SiCl₂,
alkylhydrogenodihalomonosilanes, for example CH₃SiHCl₂,
alkylalkenyldihalomonosilanes, for example (CH₃)ViSiCl₂,
dialkylalkenylhalomonosilanes, for example (CH₃)₂ViSiCl,
alkyltrihalomonosilanes, for example (CH₃)SiCl₃,
hydrogenotrihalomonosilanes, for example HSiCl₃,
alkenyltrihalomonosilanes for example ViSiCl₃,
and mixtures thereof.

The alkyl may be a C₁-C₃₀ alkyl, alkenyl, a C₂-C₃₀ alkenyl. The alkyl, alkenyl or hydrogeno substituents may be combined or replaced by an aryl. These alkyl, alkenyl or aryl groups may be optionally substituted (preferably halogenated).

The preferred alkyl and halogen are methyl and chlorine respectively and the alkenyl is preferably Vi=vinyl.

For further details on route I for preparing a hydrophobic silica suspension in a silicone oil, reference may be made to WO-A-702/44259 whose content is fully incorporated into the present disclosure.

In practice, the method according to route II may for example mainly consist in using a precipitated silica powder and in using the following operations:
the relevant products are introduced into the stirred preparation vessel in the following order:
   1. the aqueous silica suspension, optionally in several fractions, the hydrogen bond stabilizer/initiator—preferably consisting of isopropyl alcohol—, optionally an acid—preferably HCl—;
   2. a halosilane precursor of hydrophobic units: —Si—(R^{c})_{1 to 3} with R^{c} as defined above and corresponding for example to a C₁-C₁₀ alkyl or a C₂-C₁₂ alkenyl,—and still more preferably to (CH₃)₃SiCl—;
   3. part of the SM consisting of at least one oligoorganosiloxane—preferably hexamethyldisiloxane (M₂)—;
the medium is heated to a temperature in the region of the reflux temperature of the hydrogen bond stabilizer/initiator—preferably that of isopropyl alcohol between 70 and 80° C.;
the medium is optionally cooled;
the aqueous phase is separated from the nonaqueous phase—preferably by decantation—;
the nonaqueous phase is removed;
optionally at least once, this nonaqueous phase is washed with an aqueous liquid and then the aqueous washing phase is removed;
the optionally washed, nonaqueous silicone phase is mixed with all or the remainder of the silicone material SM, with the silica now hydrophobic, this SM preferably comprising at least one polyorganosiloxane POS;
an oily suspension of hydrophobic particulate silicic filler is recovered in a crosslinkable silicone material SM.

In this embodiment with powdered precipitated silica, the proportions of the various ingredients are the following (parts by dry weight for all that is not water):
silica: 100;
acid (e.g. HCl): 20 to 60, preferably from 30 to 50;
precursor of —Si—(R^{c})_{1 to 3} {e.g. (CH₃)₃SiCl}, 5 to 500, preferably from 10 to 2200;
H bond stabilizer/initiator (e.g. isopropanol): 0 to 20, preferably from 1 to 10;
SM oil: 40 to 2 000, consisting exclusively or otherwise of oligoorganosiloxane—preferably of M₂;
water: 2 to 8 000, preferably 200 to 1 000.

The silica used exists in practice essentially in the form of a precipitated silica slurry. This avoids the step for preparing the slurry in the preparation vessel. Moreover, it is clear that the handling of a slurry is much easier than the handling of large volumes of powder, which furthermore require expelling the corresponding air from the mixture during production.

The dryness of the silica slurry is generally between 1 and 50% by weight, preferably between 10 and 40% by weight.

This novel method of preparation is found to be particularly economical and allows easy incorporation of the ingredients with tools which use little energy. Indeed, the composition remains easily malleable during the entire process without requiring an enormous amount of power for the mixing. This method results furthermore, in the case of crosslinkable silicone elastomers, in properties for using the elastomers which are completely consistent with the expected specifications, compared with conventional methods using fumed silica. The same applies in the case of slurries intended for preparing antifoam compositions.

The various stages of the method may be of varying durations and are performed in separate appliances.

Regardless of the powder or slurry form of the precipitated silica, it is particularly advantageous to note that the degassing of the compositions for elastomers, prepared with the slurry, is much easier than previously.

As regards the silicone oils used in the method according to the invention, there may be preferably chosen linear or cyclic, and preferably linear, polydiorganosiloxanes.

Thus, the silicone material may be, in the first place, a polyaddition SM₁ containing:
at least one reactive silicone oil A POS whose crosslinking functional groups Fa are alkenyl—preferably vinyl—functional groups,
   these A POSs:
      comprising at least two Si-Fa groups per molecule, preferably each situated at one end of the chain,
      and having a dynamic viscosity at 25° C. of less than or equal to 250 Pa·s, preferably 100 Pa·s and still more preferably 10 Pa·s,
   this A POS being intended to react with the B POS,
at least one reactive silicone oil B POS, whose crosslinking functional groups Fb are hydrogen functional groups, this B POS comprising at least two groups Si—H per molecule (preferably at least three when the A POS comprises only two Si-Vi groups per molecule), these Si—H groups being advantageously situated in the chain,
and/or at least one nonreactive E POS.

For this silicone material SM₁ to be crosslinkable by polyaddition, it is necessary to add to it:
a catalytic system comprising a polyaddition metal catalyst (preferably of platinum nature) and optionally an inhibitor;
optionally one or more semireinforcing, nonreinforcing or bulking fillers;
optionally water;
optionally one or more additives chosen from pigments, plasticizers, other rheology modifiers, stabilizers and/or adhesion promoters.

The A POS may be for example an α,ω-divinylated polydialkyl-(methyl)-siloxane oil. Preferably, the A POS used for the preparation of the suspension is a vinylated A POS carrying at least two Si-Vi units per molecule, preferably at least three per molecule, when the B POS-contains only two Si—H units per molecule.

The B POS is for example polyalkyl(methyl)-hydrogenosiloxane or alternatively a branched hydrogenated POS containing tri- or tetrafunctional units and units carrying SiH.

The E POS may be a polydiorganosiloxane, such as a polyalkylsiloxane, preferably a polydimethylsiloxane with trimethylsilyl ends, optionally at the chain end and in the chain of functional groups such as for example hydroxyls.

The preferred silicone oils (A, B, E) mainly comprise R¹₂SiO units, the symbols R¹, which are identical or different, representing optionally halogenated C₁-C₁₀ (cyclo)alkyl groups, C₁-C₁₂ alkenyl groups, aryl groups, these radicals R¹ being optionally substituted or halogenated.

By way of:
alkyl groups: methyl, ethyl, propyl and butyl groups may be particularly mentioned,
halogenated alkyl groups: 3,3-trifluoropropyl may be mentioned,
cycloalkyl groups: cyclohexyl may be mentioned,
alkenyl groups: vinyl may be mentioned,
aryl groups: phenyl group may be mentioned.

For example; at least 85% of the groups R¹ represent methyl groups.

Secondly, the silicone material may be a polycondensation SM₂ containing:
at least one reactive silicone oil C POS whose crosslinking functional groups Fc react by polycondensation, these C POSs corresponding to the following formula (1): 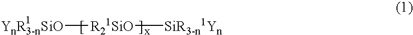
   in which:
   R¹ represents monovalent hydrocarbon radicals which are identical or different, and Y represents hydrolysable or condensable groups OR¹¹ with R¹¹ corresponding to the same definition as that given above for R^{c},
   n is chosen from 1, 2 and 3 with n=1, when Y is a hydroxyl, and x has a sufficient value to confer on the oils of formula (1) a dynamic viscosity at 25° C. of between 1 000 and 200 000 mPa·s,
this C POS being intended to react with another C POS or with at least one crosslinking agent D,
and/or at least one nonreactive E POS different from the C POS(s).

For this silicone material to be crosslinkable by polycondensation, it is necessary to add to it:
a catalytic system comprising a condensation metal catalyst;
optionally one or more semireinforcing, nonreinforcing or bulking fillers;
optionally water;
optionally one or more additives chosen from pigments, plasticizers, other rheology modifiers, stabilizers and/or adhesion promoters.

In the products of general formula (1) which are industrially used, at least 80% in numerical terms of the radicals R are methyl radicals, the other radicals may generally be phenyl radicals.

As examples of hydrolysable groups Y, there may be mentioned the amino, acylamino, aminoxy, cetiminoxy, iminoxy, enoxy, alkoxy, alkoxyalkyleneoxy, acyloxy and phosphato groups, and for example among these:
for the amino groups Y: n-butylamino, sec-butylamino and cyclohexylamino groups,
for the N-substituted acylamino groups: the benzoylamino group,
for the aminoxy groups: the dimethylaminoxy, diethylaminoxy, dioctylaminoxy and diphenylaminoxy groups,
for the iminoxy and cetiminoxy groups: those derived from acetophenone oxime, acetone oxime, benzophenone oxime, methylethyl ketoxime, diisopropyl ketoxime and chlorocyclohexanone oxime,
for the alkoxy groups Y: the groups having from 1 to 8 carbon atoms such as methoxy, propoxy, isopropoxy, butoxy, hexyloxy and octyloxy groups,
for the alkoxyalkyleneoxy groups Y: the methoxyethyleneoxy group,
for the acyloxy groups Y: the groups having from 1 to 8 carbon atoms such as the formyloxy; acetoxy, propionyloxy and 2-ethylhexanoyloxy groups,
for the phosphato groups Y: those derived from the dimethyl phosphate, diethyl phosphate and dibutyl phosphate groups.

As condensable groups Y, there may be mentioned hydrogen atoms and halogen, preferably chlorine, atoms.

The reactive C POSs preferably used are the α,ω-dihydroxylated diorganopolysiloxanes of formula (1) in which Y=OH, n=1 and x has a sufficient value to confer on the polymers a dynamic viscosity at 25° C. of between 1 000 and 200 000 mPa·s and preferably between 5 000 and 80 000 mPa·s.

It should be understood that, in the context of the present invention, it is possible to use as hydroxylated C POSs of formula (1) a mixture consisting of several hydroxylated polymers which differ from each other by the value of the viscosity and/or the nature of the substituents linked to the silicon atoms. It should be indicated furthermore that the hydroxylated polymers of formula (1) may optionally comprise, apart from the D units of formula R₂SiO, T units of formula RSiO_{3/2} and/or Q units of formula SiO₂ in the proportion of at most 1% (these percentages expressing the number of T and/or Q units per 100 silicon atoms).

This polycondensation SM₂ may also comprise a nonreactive silicone oil comprising nonreactive E POSs corresponding to the following formula (2):

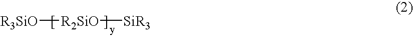

in which:
the substituents R, which are identical or different, represent monovalent hydrocarbon radicals,
the symbol y has a sufficient value to confer on the polymers a dynamic viscosity at 25° C. of between 10 and 10 000 mPa·s.

As examples of radicals R, there may be mentioned the alkyl radicals having from 1 to 8 carbon atoms, such as methyl, ethyl, propyl, butyl, hexyl and octyl radicals, and phenyl radicals.

As examples of substituted radicals R, there may be mentioned the 3,3,3-trifluoropropyl, chlorophenyl and beta-cyanoethyl radicals.

By way of illustration of units represented by the formula R₂SiO, there may be mentioned those of formulae:
(CH₃)₂SiO; CH₃(C₆H₅)SiO; (C₆H₅)₂SiO; CF₃CH₂CH₂(CH₃)SiO; NC—CH₂CH₂(CH₃)SiO.

It should be indicated furthermore that the hydroxylated polymers of formula (2) may optionally comprise, apart from the D units of formula R₂SiO, T units of formula RSiO_{3/2} and/or SiO₂ units in the proportion of at most 1% (these percentages expressing the number of T and/or Q units per 100 silicon atoms).

The crosslinking agents D intended to react with the C POSs of the polycondensation SM carry hydroxyl crosslinking. Functional groups Fd and/or OR functional groups (R=C₁-C₂₀ alkyl) precursor of the functional groups Fd, these crosslinking functional groups being capable of reacting with other functional groups Fc of the C POS and/or Fd of the crosslinking agent D. The latter is preferably chosen from:
the silanes of general formula:
   R₄₋ₐSiY′ₐ (3)
in which:
   the substituents R, which are identical or different, have the same general or specific meanings as those given above in formula (1),
   the symbols Y′, which are identical or different, represent the same hydrolysable or condensable groups as those mentioned above in relation to the groups Y of formula (1),
the products of partial hydrolysis of a silane of formula (3), the said crosslinking agent D being obligatory when the reactive C POS(s) are α,ω-dihydroxylated POSs, and optional (but desirable) when the reactive C POS(s) carry at each chain end condensable groups (other than OH) or hydrolysable groups.

As other examples of crosslinking agents D selected from monomeric silanes, there may be mentioned more particularly polyacyloxysilanes, polyalkoxysilanes, polyketiminoxysilanes and polyiminoxysilanes, and in particular the following silanes:

CH₃Si(OCOCH₃)₃; C₂H₅Si(OCOCH₃)₃; (CH₂═CH)Si(OCOCH₃)₃; C₆H₅Si(OCOCH₃)₃; CF₃CH₂CH₂Si(OCOCH₃)₃; NC—CH₂CH₂Si(OCOCH₃)₃; CH₂ClSi(OCOCH₂CH₃)₃; CH₃Si[ON═C(CH₃)C₂H₅]₂(OCH₂CH₂OCH₃); CH₃Si[ON═CH—(CH₃)₂]₂(OCH₂CH₂OCH₃); Si(OC₂H₅)₄; Si(O-n-C₃H₇)₄; Si(O-isoC₃H₇)₄; Si(OC₂H₄OCH₃)₄; CH₃Si(OCH₃)₃; CH₂═CHSi(OCH₃)₃; CH₃Si(OC₂H₄OCH₃)₃; ClCH₂Si(OC₂H₅)₃; CH₂═CHSi(OC₂H₄OCH₃)₃.

The products of partial hydrolysis, for example, of the polyalkoxysilanes, usually called polyalkyl silicates, are well known products. The product most commonly used is polyethyl silicate 40® obtained from the partial hydrolysis of Si(OC₂H₅)₄.

The crosslinking agents D preferably used in the case of the preferred use of α,ω-dihydroxylated POSs of formula (1) are the alkyltrialkoxysilanes and the tetraalkoxysilanes of formula (3) where R represents an alkyl radical having from 1 to 4 carbon atoms, and the products of partial hydrolysis of these preferred silanes.

Thirdly, the silicone material SM may be of the SM₃ type crosslinkable by polydehydrogeno-condensation. The B′ and C′ POSs of SM₃ correspond to the same definitions as those given above for the B and C POSs respectively.

Persons skilled in the art are capable of incorporating into SM₃ the catalyst and the appropriate optional additives.

Thus, the invention also relates to a method for preparing a silicone composition which can be crosslinked by polydehydrogenocondensation, characterized in that a polydehydrogenocondensation SM₃ is used which contains:
at least one C′ type-POS carrying hydroxyl crosslinking functional groups Fc′ and/or OR′ functional groups (R′=C₁-C₃₀ alkyl, C₂-C₃₀ alkenyl, aryl, optionally substituted (preferably halogenated)) precursor of the functional groups Fc′, these crosslinking functional groups Fc′ being capable of reacting with other crosslinking functional groups F′ (SiH) of at least one B′ type POS, this C′ PPO being taken alone or as a mixture with at least one nonreactive (E) POS;
at least one reactive silicone oil B′ POS, whose crosslinking functional groups Fb′ are hydrogen functional groups, this B′ POS comprising at least two ≡Si—H groups per molecule (preferably at least three when the A POS comprises only two ≡Si-Vi-groups per molecule), these ≡Si—H groups being advantageously present in the chain;
and/or at least one nonreactive E POS;
   and in that the following are incorporated:
a catalytic system comprising a polydehydrogenocondensation metal catalyst (preferably of platinum nature) and optionally an inhibitor;
optionally one or more semireinforcing, nonreinforcing or bulking fillers;
optionally water;
optionally one or more additives chosen from pigments, plasticizers, other rheology modifiers, stabilizers and/or adhesion promoters.

The role of the reinforcing filler/silicone oil suspension prepared in accordance with the invention is to be used in the production of liquid or pasty silicone compositions which can be crosslinked by polyaddition or polycondensation, preferably to a silicone elastomer in an ambient atmosphere at normal temperature or at a higher temperature, or of nonreactive (antifoam) liquid or pasty silicone compositions.

Accordingly, according to another of its aspects, the present invention relates to a method for producing a silicone composition which can be crosslinked by polyaddition, consisting in incorporating in particular into the suspension as prepared according to the method as defined above, the following products:
optionally one or more A POSs as defined above,
one or more B POSs as defined above,
optionally one or more nonreactive E POSs as defined above, which are useful as diluents,
a catalytic system comprising a catalyst, preferably of platinum nature, and optionally an inhibitor.

According to a first variant of this method:
the composition is produced in the form of two-component systems P₁ and P₂ intended to be brought into contact with each other in order to produce an elastomer crosslinked by polyaddition between the A and B POSs,
and the method is carried out such that only one of the parts P₁ or P₂ contains catalyst ε, the other containing the B POS.

According to a second variant of this method for preparing crosslinkable liquid compositions, a one-component system is prepared which is intended to crosslink in the ambient air and/or under the effect of temperature.

These compositions which can be crosslinked by polyaddition to elastomers may also comprise one or more functional additives A, such as for example a nonreinforcing filler consisting of chalk, quartz powder, diatomaceous earth, mica, kaolin, aluminas or iron oxides. These optional additives η may also consist of pigments, antiblocking agents, plasticizers or rheology modifiers, stabilizers or adhesion promoters.

The invention also relates to a method for producing a silicone composition which can be crosslinked by polycondensation, characterized in that it consists in incorporating, in particular into the suspension as prepared according to the method as defined above, the following products:
β′—optionally one or more C POSs as defined above;
δ′—one or more crosslinking agents D;
γ′—optionally one or more E POSs, as defined above and useful as diluents;
ε′—a catalytic system comprising a condensation catalyst;
ν′ optionally one or more semi-reinforcing, nonreinforcing or bulking fillers;
ρ′—optionally water;
κ′—optionally one or more additives chosen from pigments, plasticizers, other rheology modifiers, stabilizers and/or adhesion promoters.

As regards the fillers ν′, they generally have a particulate diameter greater than 0.1 μm and are preferably chosen from ground quartz, zirconates, calcined clays, diatomaceous earth, calcium carbonate and aluminas.

According to a first variant of the method for producing a silicone composition which can be crosslinked or hardened by polycondensation to an elastomer, a one-component composition (that is to say having a single packaging), is produced which is intended to crosslink in the presence of moisture, in particular moisture provided by ambient air or by the water present and/or added to the composition, at room temperature and/or under the effect of temperature which may range for example from 25° C. to a value of less than 100° C. In this case, the crosslinking catalyst ε′ used is a metal catalyst which is chosen in particular from tin monocarboxylates, diorganotin dicarboxylates, a tin chelate of valency IV, a hexacoordinated tin chelate of valency IV, amino silanes, an organic derivative of titanium, an organic derivative of zirconium.

According to a second variant of the method for preparing compositions which can be crosslinked to elastomers:
each composition is produced in the form of a two-component (or two-package) system P1 and P2, intended to be brought into contact with each other in order to give a polycondensation elastomer,
and the procedure is carried out such that only one of the parts P1 or P2 contains the catalyst ε′ and optionally the crosslinking agent(s) D, excluding the C POS.

In the case of the two-component compositions, the polycondensation catalyst ε′ used is preferably an organic derivative of tin as defined above, an amine or a mixture of these species or an organic derivative of titanium.

The mixtures used in these methods may be produced using known and appropriate devices. They may be for example conventional mixers customarily used for these preparations:
arm mixers,
internal mixers,
planetary mixers,
ploughshare mixers,
co- or counterrotating twin-shaft mixers,
continuous extruder-mixers,
or other batch or continuous devices:
   stirred reactors,
   static mixers.

The mixing operation is carried out at normal temperature and pressure and preferably under an inert atmosphere (N₂) It is in fact advisable that, under these conditions, the silicone oil, the water, but also the compatibilizing agent, are in liquid form in order to facilitate the mixing.

The examples which follow illustrate:
the preparation of the reinforcing filler suspensions in a silicone material, in accordance with the invention,
the application of these suspensions as raw material for the production of two-component compositions which can be crosslinked to polyaddition RTV II silicone elastomers,
and the evaluation of the viscoelastic properties of the suspensions and of the mechanical properties of the elastomers crosslinked by polyaddition which are obtained from the said suspensions.

### EXAMPLES

Preparation 1:

In a uniaxial mixer equipped with a three-blade butterfly-type-stirrer, 200 g of precipitated silica Zeosil® 132 from Rhodia are incorporated into 465 g of, demineralized water and the suspension is mixed at 336 rpm until a smooth and homogeneous paste is obtained. 41.2 g of hexamethyldisilazane (HMDZ) are then added over one hour, with stirring, and the mixing is continued for thirty minutes at 336 rpm. 272 g of α,ω-dihydroxylated polydimethylsiloxane oil (“hydroxylated” oil) having a viscosity of about 14 000 mPa·s are added to the tank. The whole forms a paste.

After ten minutes, the phase separation, described in patent WO 02/44259, then occurs but the stirring is continued for one hour at 300 rpm.

The aqueous phase containing 388 g of clear water (without silica) is withdrawn from the mixer and

the silicone phase, remaining in the tank is again stirred. 175 g of α,ω-dihydroxylated polydimethylsiloxane oil (“hydroxylated” oil) having a viscosity of around 50'000 mPa·s are then added to the tank and the whole is heated, under a nitrogen stream, for 1 h 30 min at about 100° C.

A sample is then collected in order to analyse the rheology thereof.

Preparations 2 to 6:

In a uniaxial mixer equipped with a three-blade butterfly-type stirrer, 200 g of precipitated silica Zeosil® 132 from Rhodia are incorporated into 465 g of demineralized water and the suspension is mixed at 336 rpm until a smooth and homogeneous paste is obtained. 41.2 g of hexamethyldisilazane (HMDZ) are then added and the treatment of the silica is allowed to proceed for 1 h 30 min at 336 rpm. 272 g of α,ω-dihydroxylated polydimethylsiloxane oil (“hydroxylated” oil) having a viscosity of about 14 000 mPa·s are added, to the tank. After ten minutes, the two phases begin to separate but the stirring is continued for one hour at 300 rpm.

The aqueous phase containing about 380-400 g of clear water (without silica) is withdrawn from the mixer and the silicone phase remaining in the tank is stirred again. 175 g of α,ω-dihydroxylated polydimethylsiloxane oil (“hydroxylated” oil) having a viscosity of about 50 000 mPa·s are then added to the tank followed by a quantity x of α,ω-dihydroxylated polydimethylsiloxane oil (“hydroxylated” oil) of very low viscosity (4-5 Si pet chain) and the whole is heated under a nitrogen stream for 1 h 30 min at about 100° C. The heating is continued at 150° C. for 2 h under vacuum (about 20-50 mmHg).

The medium is then cooled and when the temperature has fallen to about 60° C., 143 g of α,ω-tri-methylsilylpolydimethylsiloxane oil (“methylated” oil) having a viscosity of about 50 mPa·s and 21.6 g of fluid hydroxylated oil are added, with stirring. After mixing for 30 min (still at 336 rpm), the tank is emptied.

TABLE 1

| | Preparation | | | | |
|---|---|---|---|---|---|
| | 2 | 3 | 4 | 5 | 6 |
| X | 0 | 1 | 3 | 5 | 7 |

Preparation 7:

In a uniaxial mixer equipped with a three-blade butterfly-type stirrer, 200 g of precipitated silica-Zeosil® 132 from Rhodia are incorporated into 465 g of demineralized water and the suspension is mixed at 336 rpm until a smooth and homogeneous paste is obtained. 41.2 g of hexamethyldisilazane (HMDZ) are then added and the treatment of the silica is allowed to proceed for 1 h 30 min at 336 rpm. 272 g of α,ω-dihydroxylated polydimethylsiloxane oil (“hydroxylated” oil) having a viscosity of about 14 000 mPa·s are added to the tank. After ten minutes, the two phases begin to separate but the stirring is continued for one hour at 300 rpm.

The aqueous phase containing 402 g of clear water (without silica) is withdrawn from the mixer and the silicone phase remaining in the tank is stirred again. 122.5 g of α,ω-dihydroxylated polydimethylsiloxane oil (“hydroxylated” oil) having a viscosity of about 50 000 mPa·s are then added to the tank followed by 5 g of α,ω-dihydroxylated polydimethylsiloxane oil (“hydroxylated” oil) of very low viscosity (4-5 Si per chain) and the whole is heated under a nitrogen stream for 1 h 30 min at about 100° C.

A sample is then collected in order to analyse the rheology thereof.

Results

The rheology of the preparations is studied either by means of a Haake RS75 rheometer with a cone-plate geometry, or by means of a Brookfield needle viscometer.

Study of the Consistency and of the Impact of the Addition of Fluid Hydroxylated Oil on the Consistency of the Mixture

A measurement of flow is carried out (Ti cone of 20 mm in diameter for an angle of 20°, at 23° C.). Table 2 below gives the values of the gradients (in s⁻¹) as a function of the stress. The lower the gradient, the higher the consistency of the product.

TABLE 2

| | Preparation 1 | Preparation 7 |
|---|---|---|
| Silica level | About 29% | About 31.2% |
| Stress (Pa) | Gradient (s⁻¹) | Gradient (s⁻¹) |
| 1 000 | 0.053 | 0.28 |
| 4 000 | 0.34 | 1.66 |

Comments: As observed, the addition of hydroxylated oil had a strong effect of reducing the consistency of the product since despite the substantial increase in the silica level, the gradient values are much lower in preparation 7 than in preparation 1. This makes it possible to consume less power during the process.
Study of the Final Viscosity of the Products

The viscosity of the products is monitored as a function of x. The measurement is carried out with the No. 7 needle of the Brookfield viscometer by producing a speed gradient. The viscosity value is taken after one minute.

Table 3 below gives the conditions and the experimental results.

TABLE 3

| | Prepara- | Prepara- | Prepara- | Prepara- | Prepara- |
|---|---|---|---|---|---|
| | tion 2 | tion 3 | tion 4 | tion 5 | tion 6 |
| x | 0 | 1 | 3 | 5 | 7 |
| Silica | 23.0 | 23.0 | 22.9 | 22.9 | 22.8 |
| level (%) | | | | | |
| Speed of | | | | | |
| rotation of | | | | | |
| the needle | | | | | |
| (rpm) | | | | | |
| | Viscosity (measurement after | | | | |
| | 1 week of storage) (Pa · s) | | | | |
| 0.5 | 392 | 280 | 184 | 160 | 136 |
| 1 | 316 | 220 | 156 | 132 | 124 |
| 2.5 | 259 | 187 | 138 | 114 | 110 |
| 5 | 230 | 169 | 123 | 103 | 99.2 |
| 10 | 208 | 155 | 114 | 95 | 91 |
| | Viscosity (measurement at | | | | |
| | 10-11 weeks) (Pa · s) | | | | |
| 0.5 | 440 | 368 | 192 | 126 | 128* |
| 1 | 352 | 272 | 168 | 124 | 120* |
| 2.5 | 272 | 210 | 147 | 120 | 107* |
| 5 | 238 | 178 | 132 | 109 | 98.4* |
| 10 | 213 | 156 | 120 | 100 | 91.6* |

*measurement at 9 weeks

Comments: The variation in the silica level is not significant. On the other hand, the reduction in the viscosity of the slurries with the increase in x is very high (from 400 Pa·s to 130 Pa·s).

Moreover, the slurries are stable over time, as shown by the absence of variation in viscosity over several weeks.

Preparation 8:

In a uniaxial mixer equipped with a three-blade butterfly-type stirrer, 200 g of precipitated silica Zeosil® 132 from Rhodia are incorporated into 465 g of demineralized water and the suspension is mixed at 400 rpm until a smooth and homogeneous paste is obtained. 41.2 g of hexamethyldisilazane (HMDZ) are then added and the treatment of the silica is allowed to proceed for 1 h 15 min at 400 rpm. 272 g of α,ω-dihydroxylated polydimethylsiloxane oil (“hydroxylated” oil) having a viscosity of about 14.000 mPa·s are added to the tank. After ten minutes, the two phases begin to separate but the stirring is continued for one hour at 400 rpm.

The aqueous phase containing about 400 g of clear water (without silica) is withdrawn from the mixer and the silicone phase remaining in the tank is stirred again. 122 g of α,ω-dihydroxylated polydimethylsiloxane oil (“hydroxylated” oil) having a viscosity of about 14 000 mPa·s are then added to the tank followed by 105 g of α,ω-dihydroxylated polydimethylsiloxane oil (“hydroxylated” oil) of very low viscosity (4-5 Si per chain) and the whole is heated under a nitrogen stream for 1 h 30 min at about 100° C.

The heating is continued at 150° C. for 2 h under vacuum (about 20-50 mmHg). The medium is then cooled, and when the temperature has fallen to about 60° C., 143 g of α,ω-trimethylsilylpolydimethylsiloxane oil (“methylated” oil) having a viscosity of about 50 mPa·s, 53.0 g of “hydroxylated” oil having a viscosity of 14 000 mPa·s and 10.0 g of fluid hydroxylated oil are added, with stirring. After mixing for 30 min (still at 400 rpm), the tank is emptied.

Subsequently, at least 24 h after the formulation of the slurry, the composition was crosslinked with a catalyst containing a mixture of silanes and a tin-based polycondensation catalyst in the proportions 100/1.5.

Results

No additive-free control (fluid hydroxylated oil) could be formulated because of the excessively high viscosity. The rheology of the preparations is studied by means of a Brookfield needle viscometer. The measurements are carried out with the No. 7 needle and a speed of rotation of 10 rpm. The mechanical properties are studied on a dumb-bell shaped test piece (for the breaking tensile stress) or a notched bean shaped test piece (for the tearing tensile stress) using an XXX dynamometer.

Preparation 9:

| Silica level | about 24.2% |
|---|---|
| Viscosity (Pa · s) | 58 |
| Properties on a crosslinked film | |
| Hardness (Shore A) | 19 |
| Tear strength (kN/m) | 32 |
| Rupture strength (MPa) | 6.0 |
| Breaking elongation (%) | 508 |
| Modulus at 100% (MPa) | 0.55 |

1. A method for preparing a suspension of a silicic particulate filler, in a silicone material (SM) comprising:
SM₁polyaddition:
at least one type A polyorganosiloxane POS carrying alkenyl crosslinking functional groups Fa capable of reacting with the crosslinking functional groups Fb (SiH) of at least one B type POS, this A POS being taken alone or as a mixture with at least one nonreactive (E) POS;
and at least one B type POS carrying crosslinking functional groups Fb (SiH) capable of reacting with the alkenyl crosslinking functional groups Fa of the A POS(s);
and/or SM₂polycondensation:
at least one C type POS carrying hydroxyl crosslinking functional groups Fc and/or OR functional groups (R=C₁-C₃₀ alkyl, C₂-C₃₀ alkenyl, aryl, which are optionally substituted (preferably halogenated)) precursor of the functional groups Fc′, these crosslinking functional groups Fc being capable of reacting with crosslinking functional groups Fc of this C POS or of other C POSs, and with crosslinking functional groups of at least one crosslinking agent D, this C POS being taken alone or as a mixture with at least one nonreactive (E) POS;
and/or SM₃polydehydrogenocondensation:
at least one C′ type POS carrying hydroxyl crosslinking functional groups Fc′ and/or OR′ functional groups (R′=C₁-C₃₀ alkyl, C₂-C₃₀ alkenyl, aryl, which are optionally substituted (preferably halogenated)) precursor of the functional groups Fc′, these crosslinking functional groups Fc′ being capable of reacting with other crosslinking functional groups Fb′(SiH) of at least one B′ type POS, this C′ POS being taken alone or as a mixture with at least one nonreactive (E) POS;
and at least one B′ type POS carrying crosslinking functional groups Fb′(SiH) capable of reacting with the crosslinking functional groups Fb′OH or OR′ of the C′ POS(s);
and/or SM₄:
or at least one nonreactive (E) POS;
this suspension being capable of being used in particular for producing compositions which can be crosslinked by polyaddition and/or by polycondensation and/or by dehydrogenocondensation or antifoam silicone compositions;
this method being of the type in which an aqueous suspension of silicic particulate filler is made hydrophobic by treating with at least one halogenated reagent, this treatment comprising a transfer of the silica made hydrophobic into a nonaqueous phase and at least one step for at least partial removal of water;
the compatibilizing agent (CA) being:
CA I (Route I): either selected from silazanes, taken alone or as a mixture with each other, preferably from disilazanes, hexamethyldisilazane (HMDZ) combined or otherwise with divinyltetramethyldisilazane being particularly preferred;
CA II (Route II): or selected from R^{c}-substituted halogenosilanes with R^{c}=hydrogeno, C₁-C₃₀ alkyl, C₂-C₃₀ alkenyl, aryl, and R^{c} being optionally substituted (preferably halogenated), preferably from R^{c}-substituted chlorosilanes and the mixtures thereof;
the said method comprising:
1. in that
according to route I:
Ia)—the particulate filler is selected from the group of precipitated silicas,
Ib)—the compatibilizing agent (CA.I) is added in one or more fractions which are quantitatively and/or qualitatively identical to or different from each other, to the preparation medium,
Ic)—the mixing of all or part of the SM, of the filler, of water, and of the CA or CAs is optionally partly carried out in the hot state and in such a manner that the quantity of water is such that the weight ratio r=(water/water+silica)×100 is defined as follows: 40≦r≦99, preferably 60≦r≦90,
Id)—optionally at least some of the water released and of the by-products of the reaction of CA.I with SM and with the filler are drawn off,
Ie)—the volatile species are optionally removed, preferably in the hot state under a gaseous stream or under vacuum,
If)—and cooled if necessary,
according to route II:
IIa)—an aqueous silica suspension is prepared or used which comprises:
silica,
water which is optionally acidified,
at least one hydrogen bond stabilizer,
IIb)—optionally, part of the silicone material SM is incorporated into the aqueous silica suspension obtained at the end of step IIa),
IIc)—hydrophobic units formed by ≡Si—(R^{c})_{1 to 3} with R^{c}=hydrogeno, C₁-C₃₀ alkyl, C₂-C₃₀ alkenyl, aryl, these groups R^{c} being optionally substituted (preferably halogenated), are grafted onto the silica by exposing this silica to halosilane type CA II acting as precursors of these units and by allowing the reaction to proceed, preferably while stirring the whole, optionally in the hot state,
IId)—the procedure is carried out such that the transfer of the silica grafted by hydrophobic units, from the aqueous phase to the nonaqueous phase, is carried out,
IIe)—optionally, at least part of the aqueous phase and of the reaction byproducts is drawn off,
IIf)—the medium is cooled if necessary,
IIg)—optionally, the residual acidity of the nonaqueous phase is washed off,
IIh)—the totality or the remainder of the silicone material SM is mixed with the filler which is now hydrophobic,
IIi)—the residual water is evaporated off,
IIj)—and an oil is recovered which comprises a hydrophobic particulate filler suspension in a crosslinkable silicone material, preferably without ever passing via a dried hydrophobic silica,
the routes I and II leading to an oil (or slurry) comprising a suspension of hydrophobic particulate filler in a crosslinkable silicone material;
2. and at least one other compatibilizing agent (CA III) is used which is chosen from the group consisting of:
(i) POSs carrying in and/or at the ends of their chains compatibilizing functional groups OR^{IIIi} in which R^{IIIi} independently corresponds to hydrogen or to a radical corresponding to the same definition as given above for R^{c};
(ii) siloxane resins;
(iii) silanes;
(iv) and mixtures thereof;
excluding:
di- or monofunctional low-molecular-weight (advantageously less than 1 000 g/mol) siloxanes with hydroxyl ends;
amines, such as, for example alkylamines, (such as diethylamine) and/or silylamines;
and surfactants and more Particularly cationic surfactants.

2. The method according to claim 1, wherein the compatibilizing agent (CA III) is chosen from the group consisting of:
(I) POSs carrying in and/or at the ends of their chains compatibilizing functional groups OR^{IIIi} in which R^{IIIi} independently corresponds to hydrogen or to a radical corresponding to the same definition as given above for R^{c};
(ii) siloxane resins;
(iii) silanes;
(iv) and mixtures thereof;
provided that C1 according to which if CA=CA I and if CA III comprises at least one α,ω-dihydroxylated POS (i),
then the latter is combined with at least one element of the subgroups (ii) to (iii);
and without excluding:
di- or monofunctional low-molecular-weight (advantageously less than 1 000 g/mol) siloxanes with hydroxyl ends;
amines, such as, for example alkylamines, (such as diethylamine) and/or silylamines;
and surfactants and more particularly cationic surfactants.

3. The method according to claim 1, wherein the compatibilizing agent (CA III) is chosen from the group consisting of:
(i) POSs carrying in and/or at the ends of their chains compatibilizing functional groups OR^{IIIi} in which R^{IIIi} independently corresponds to hydrogen or to a radical corresponding to the same definition as given above for R^{c};
(ii) siloxane resins;
(iii) silanes;
(iv) and mixtures thereof;
provided that C2 according to which if CA=CA I, then CA/is different from any compatibilizing agent selected from silazanes, taken on their own or as a mixture with each other, in particular disilazanes such as hexamethyldisilazane (HMDZ) combined or otherwise with divinyltetramethyldisilazane:
and without excluding:
di- or monofunctional low-molecular-weight (advantageously less than 1 000 g/mol) siloxanes with hydroxyl ends;
amines, such as, for example alkylamines, (such as diethylamine) and/or silylamines;
and surfactants and more particularly cationic surfactants.

4. The method according to claim 1, wherein the compatibilizing agent (CA III) is chosen from the group consisting of:
(i) POSs carrying in and/or at the ends of their chains compatibilizing functional groups OR^{IIIi} in which R^{IIIi} independently corresponds to hydrogen or to a radical corresponding to the same definition as given above for R^{c};
(ii) siloxane resins;
(iii) silanes;
(iv) and mixtures thereof;
and wherein this compatibilizing agent (CA III) is combined with at least one condensation catalyst preferably selected from:
strong bases, and still more preferably from the subgroup comprising KOH, LiOH, NaOH and mixtures thereof;
metal salts, and still more preferably from the subgroup comprising tin salts, titanium salts and mixtures thereof;
salts of triflic acid;
and mixtures thereof;
and without excluding:
di- or monofunctional low-molecular-weight (advantageously less than 1 000 g/mol) siloxanes with hydroxyl ends;
amines, such as, for example alkylamines, (such as diethylamine) and/or silylamines;
and surfactants and more particularly cationic surfactants.

5. The method according to claim 1, wherein the compatibilizing agent CA II is incorporated after CA I or CA II, preferably after drawing off all or part of the aqueous phase, provided that the said drawing off takes place.

6. The method according to claim 1, wherein CA III is added in an amount of 0.5 to 40% by weight, preferably 0.5 to 30% by weight relative to the quantity of silicic particulate filler used in the suspension.

7. The method according to claim 1, wherein there are chosen:
one or more precipitated silicas, preferably existing mainly in slurry form and whose BET specific surface area is between 50 and 400 m²/g,
and mixing conditions such that the dynamic viscosity at 25° C. of the suspension is less than or equal to 300 Pa·s, preferably less than or equal to 150 Pa·s.

8. The method according to claim 1, wherein in route II, at least one precursor of silicone resin MQ, preferably a silicate, and still more preferably a sodium silicate, is used in step IIa).

9. The method according to claim 1, wherein in route II, the hydrogen bond stabilizer/initiator is chosen from organic solvents, preferably from the group comprising alcohols, ketones, amides, alkanes and mixtures thereof.

10. The method according to wherein in route II, the acidification of the aqueous suspension (aqueous phase) is carried out using an acid, preferably an inorganic acid, and still more preferably an acid is chosen from the group consisting of HCl, H₂SO₄, H₃PO₄ and mixtures thereof.

11. The method according to claim 1, wherein, in route II, the silicone material SM comprises at least one oligoorganosiloxane, preferably a diorganosiloxane, and still more preferably hexamethyldisiloxane (M₂).

12. The method according to claim 1, wherein the silica used is precipitated silica(s).

13. The method according to claim 1, wherein a polyaddition SM SM₁ is used which contains:
at least one reactive silicone oil A POS whose crosslinking functional groups Fa are alkenyl—preferably vinyl—functional groups,
these A POSs:
comprising at least two Si-Fa groups per molecule, preferably each situated at one end of the chain,
and having a dynamic viscosity at 25° C. of less than or equal to 250 Pa·s, preferably 100 Pa·s and still more preferably 10 Pa·s,
this A POS being intended to react with the B POS,
at least one reactive silicone oil B POS, whose crosslinking functional groups Fb are hydrogen functional groups, this B POS comprising at least two groups Si—H per molecule (preferably at least three when the A POS comprises only two Si-Vi groups per molecule), these Si—H groups being advantageously situated in the chain,
and/or at least one nonreactive E POS;
and wherein the following are incorporated:
a catalytic system comprising a polyaddition metal catalyst (preferably of platinum nature) and optionally an inhibitor;
optionally one or more semireinforcing, nonreinforcing or bulking fillers;
optionally water;
optionally one or more additives chosen from pigments, plasticizers, other rheology modifiers, stabilizers and/or adhesion promoters.

14. The method according to claim 1, wherein a polycondensation SM SM₂ is used which contains:
at least one reactive silicone oil C POS whose crosslinking functional groups Fc react by polycondensation, these C POSs corresponding to the following formula (1): 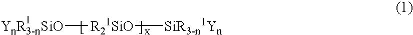
in which:
R¹ represents monovalent hydrocarbon radicals which are identical or different, and Y represents hydrolyzable or condensable groups OR¹¹ with R¹¹ corresponding to the same definition as that given above for R^{c},
n is chosen from 1, 2 and 3 with n=1, when Y is a hydroxyl, and x has a sufficient value to confer on the oils of formula (1) a dynamic viscosity at 25° C. of between 1 000 and 200 000 mPa·s,
this C POS being intended to react with another C POS or with at least one crosslinking agent D,
and/or at least one nonreactive E POS different from the C POS(s); and wherein the following are incorporated:
a catalytic system comprising a condensation metal catalyst;
optionally one or more semireinforcing, nonreinforcing or bulking fillers;
optionally water;
optionally one or more additives chosen from pigments, plasticizers, other rheology modifiers, stabilizers and/or adhesion promoters.

15. The method according to claim 1, wherein a polydehydrogeno-condensation SM SM₃ is used which contains:
at least one C′ type POS carrying hydroxyl crosslinking functional groups Fc′ and/or OR′ functional groups (R′=C₁-C₃₀ alkyl, C₂-C₃₀ alkenyl, aryl, optionally substituted (preferably halogenated)) precursor of the functional groups Fc′, these crosslinking functional groups Fc′ being capable of reacting with other crosslinking functional groups Fb′ (SiH) of at least one B′ type POS, this C′ POS being taken alone or as a mixture with at least one nonreactive (E) POS;
at least one reactive silicone oil B′ POS, whose crosslinking functional groups Fb′ are hydrogen functional groups, this B′ POS comprising at least two ≡Si—H groups per molecule (preferably at least three when the A POS comprises only two ≡Si-Vi groups per molecule), these ≡Si—H groups being advantageously present in the chain;
and/or at least one nonreactive E POS;
and wherein the following are incorporated:
a catalytic system comprising a polydehydrogenocondensation metal catalyst (preferably of platinum nature) and optionally an inhibitor;
optionally one or more semireinforcing, nonreinforcing or bulking fillers;
optionally water;
optionally one or more additives chosen from pigments, plasticizers, other rheology modifiers, stabilizers and/or adhesion promoters.
